(19) United States
(12) Patent Application Publication
(10) Pub. No.: US 2021/0233679 A1
(43) Pub. Date: Jul. 29, 2021

(54) REINFORCED POWER CABLE FOR ELECTRIC ARTIFICIAL LIFT SYSTEM

(71) Applicant: Halliburton Energy Services, Inc., Houston, TX (US)

(72) Inventors: Walter Russell Dinkins, Tulsa, OK (US); John Farrar Hedges, Jr., Cochrane (CA); Bruce Richard Bennett, Sundre (CA)

(21) Appl. No.: 16/636,779

(22) PCT Filed: Mar. 7, 2019
(86) PCT No.: PCT/US2019/021200

§ 371 Date: Feb. 5, 2020

(51) Int. Cl. H01B 7/04; H01B 7/18; H01B 13/22; H01B 7/22; E21B 41/00; E21B 43/12

(52) U.S. Cl. CPC H01B 7/046; H01B 7/1865; E21B 43/128; H01B 7/228; E21B 41/0085; H01B 13/22

(57) ABSTRACT

A reinforced power cable system for use with an electric artificial lift system is provided. The system includes an electric artificial lift system. The system also includes a power cable that provides power to the electric artificial lift system from a surface of a well. The power cable includes at least one conductor positioned within a cable jacket and a braided tube with an open-weave of a reinforcing component installed around the cable jacket. Additionally, the power cable includes a coil tube welded around the braided tube.

### TECHNICAL FIELD

The present disclosure relates to reinforced power cables. More specifically, this disclosure relates to reinforced power cables for live-well insertion of an electric artificial lift system (EALS).

### BACKGROUND

In an oilfield well, an electric artificial lift system (EALS) system may be used to produce production fluids from the well to a surface of the well. EALSs may be used in well applications where fluid or pressure management is desirable to improve production from a formation surrounding the hydrocarbon wells. Installation methods generally rely on heavy kill fluids to manage pressure during workover of the hydrocarbon well. These heavy kill fluids may damage the formation resulting in a decrease in production efficiency.

To avoid use of the heavy kill fluids, the EALS may be installed in a live well (i.e., a well without the heavy kill fluids). Power cable systems used in a live well insertion of the EALS may include power cables installed within coil tubing to maintain atmospheric isolation at a wellhead during the live well installation. These power cable systems have traditionally been manufactured by pulling an unarmored power cable through the coil tubing. When the EALS is deployed downhole, the unarmored power cable is allowed to sag within the coil tubing. Pulling the power cable through the coil tubing results in additional expenses associated with the live well insertion. For example, after both the power cable and the coil tubing are manufactured separately, the power cable is pulled through the coil tubing along a straight stretch of highway to generate the final product ready for deployment downhole.

Moreover, manufacturing the coil tubing around the power cable is not possible with conventional high strength low alloy (HSLA) materials used for the coil tubing. For example, the HSLA materials require a high temperature annealing process that is performed after welding, and the high temperature of the annealing process would damage the power cable. Further, using cable armor to protect the power cable would provide too much additional weight and thickness to the power cable system for depth goals associated with live-well insertion of EALSs.

### BRIEF DESCRIPTION OF THE DRAWINGS

FIG. 1 is a cross-sectional view of an example of a well system that includes an electric artificial lift system according to some aspects of the present disclosure.

FIG. 2 is a cross-sectional view of another example of a well system that includes an electric artificial lift system according to some aspects of the present disclosure.

FIG. 3 is a sectional view of a reinforced power cable and a coil tubing of the well system of FIG. 1 according to some aspects of the present disclosure.

FIG. 4 is a perspective view of a portion of the reinforced power cable of FIG. 3 according to some aspects of the present disclosure.

FIG. 5 is a side view of a reinforcing layer installed around the reinforced power cable of FIG. 3 according to some aspects of the present disclosure.

FIG. 6 is a sectional view of a reinforced power cable positioned within coil tubing of the well system of FIG. 2 according to some aspects of the present disclosure.

FIG. 7 is a flowchart of a process for manufacturing the reinforced power cable and the coil tubing of FIG. 3 according to some aspects of the present disclosure.

### DETAILED DESCRIPTION

Certain aspects and examples of the disclosure relate to reinforced power cables for live-well insertion of electric artificial lift systems (EALSs). The reinforced power cables provide power to the EALSs while staying within a weight and thickness range that enables the EALSs to reach depth goals within a well associated with a live-well intervention completion. To achieve the depth goals, the reinforced power cable may include a power cable with an open-weave braid of a reinforcing component (e.g., metal, reinforced fiber tape, carbon fiber, etc.) situated around a cable jacket of the power cable. Further, the power cable may include a single conductor, multiphase conductors, instrument conductors, capillary tubing, fiber optics, or any combination thereof.

The open-weave braid may provide the reinforced power cable with additional support with limited additional weight and thickness. Further, the open-weave braid may enable expansion of a cable jacket of the reinforced power cable under downhole conditions (e.g., high temperatures, decompression, etc.). Enabling expansion of the cable jacket may prevent structural damage to the reinforcing power cable resulting from the cable jacket attempting to expand within a material that resists such expansion.

Moreover, coil tubing may be manufactured (e.g., welded) around the reinforced power cable. The coil tubing may provide a surface that a grease injection head, or other sealing mechanism, is able to create a seal around during live-well insertion of the reinforced power cable and the EALS. Further, the coil tubing may be made from an alloy that does not rely on an annealing process after welding. In this manner, manufacturing the coil tubing around the reinforced power cable is possible without damaging the reinforced power cable due to the high temperatures experienced during the annealing process.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

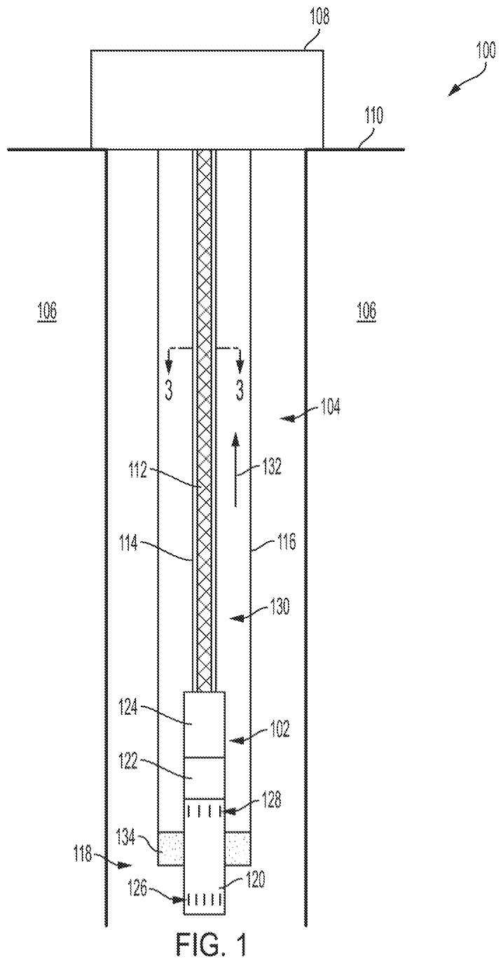

FIG. 1 is a cross-sectional view of an example of a well system 100 that includes an electric artificial lift system (EALS) 102 positioned within a wellbore 104 according to some aspects. The wellbore 104 may extend through various earth strata such as a hydrocarbon bearing subterranean formation 106. The EALS 102 may be used in the production of production fluids from the wellbore 104. For example, the EALS 102 may pump the production fluids from a downhole location within the wellbore 104 to a wellhead 108 located at a surface 110 of the wellbore 104. In an example, the EALS 102 may be an electric submersible pump (ESP), an electric submersible progressive cavity pump (ESPCP), an electric linear pump (ELP), or other form of artificial lift relying on electricity for operation. Further, in an example, the EALS 102 may be replaced by a downhole electric heater system.

As illustrated, the EALS 102 is suspended from the wellhead 108 with a reinforced power cable 112 suspended within coil tubing 114. The reinforced power cable 112 includes an open-weave braid of reinforcing material. The reinforcing material may be a metal, a carbon fiber material, a reinforced tape material (e.g., a fibrous double reverse wound reinforced tape), or any other material suitable for providing reinforcement to the power cable 112. In one or more examples, the reinforcing material may include a material (e.g., a reinforced tape material) that provides the reinforced power cable 112 with support, and provides the reinforced power cable 112 with some elasticity. For example, the elasticity of the reinforced power cable 112 may allow the reinforced power cable 112 to expand when deployed within the wellbore 104 due to heightened temperatures compared to an environment at the surface 110. Additionally, when the reinforcing material of the reinforced power cable 112 does not provide significant amounts of elasticity, the open-weave braid of the reinforcing material may enable expansion of elastomeric materials of a cable jacket of the reinforced power cable 112 under heightened temperatures of downhole conditions. The elastic expansion of the reinforced power cable 112 may maintain structural stability of the reinforcing material in environments that are likely to result in expansion of the jacket casting (e.g., at heightened downhole temperatures).

The coil tubing 114 may be made from a sheet of stainless steel alloy, and the sheet of stainless steel alloy may be molded around the reinforced power cable 112 and welded at a seam to enclose the reinforced power cable 112 within the coil tubing 114. The reinforcing material may provide protection to the reinforced power cable 112 during the welding process such that the reinforced power cable 112 does not melt under the heat of the welding process. The coil tubing 114 may provide support for the weight of the EALS 102 when the EALS 102 is run into the wellbore 104. Additionally, a seal may be established around the coil tubing 114 at the wellhead 108 when the coil tubing 114 and the reinforced power cable 112 are run into the wellbore 104 during a live-well insertion of the EALS 102. The coil tubing 114 and the reinforced power cable 112 may be stored together, prior to deployment within the wellbore 104, on a reel (not shown) at the surface 110.

The wellhead 108 may provide uphole support for both the reinforced power cable 112 and the coil tubing 114. The wellhead 108 may also electrically couple the reinforced power cable 112 to a power source (not shown) located at the surface 110. In this manner, the power from the power source may be transmitted along the reinforced power cable 112 to the EALS 102 located within the wellbore 104.

A production liner 116 may be installed within the wellbore 104 during preparation of the wellbore 104 for production. The production liner 116 (i.e., production tubing) may extend into the wellbore 104 to a production zone 118. The production zone 118 may be any area within the wellbore 104 where operators of the EALS 102 intend to produce production fluids. In an example, the production liner 116 is not cemented to the walls of the wellbore 104. For example, the production liner 116 may be hung off from a casing hanger of the wellhead 108 while the EALS 102, the reinforced power cable 112, and the coil tubing 114 is run into the wellbore 104.

Deployment of the EALS 102 in a live-well environment may involve running the reinforced power cable 112 and the coil tubing 114 through a grease injection head, or other sealing device, to maintain a pressure seal between the wellbore 104 and an environment at the surface 110. By maintaining the pressure seal, the EALS 102 is insertable within the wellbore 104 without using kill fluids that are potentially harmful to future productivity of the well system 100.

In an example, the EALS 102 is deployed within the production liner 116 in an inverted orientation. That is, the EALS 102 includes a pump section 120 located furthest downhole from the surface 110. The EALS 102 also includes a seal section 122 and a motor section 124. The pump section 120 may include fluid intake ports 126 that draw fluid into the EALS 102, and the pump section 120 may also include fluid discharge ports 128 that provide the production fluid into an annulus 130 between the coil tubing 114 and the production liner 116. The annulus 130 may form a space in which the production fluid is driven in a direction 132 toward the surface 110. The production fluid may be collected at the wellhead 108 and provided to a storage container (not shown) at the surface 110.

The fluid intake ports 126 and the fluid discharge ports 128 may be isolated from one another by a packer 134. The packer 134 may be positioned to form a seal between the EALS 102 and the production liner 116. In this manner, the annulus 130 between the coil tubing 114 and the production liner 116 is usable as path for the production fluid to travel to the surface 110.

The seal section 122 may include components that reduce a pressure differential between lubricant contained in the motor section 124 and the fluid within the wellbore 104. The motor section 124 may provide the mechanical power that drives operation of the pump section 120. Further, the motor section 124 may receive electrical power from the reinforced power cable 112.

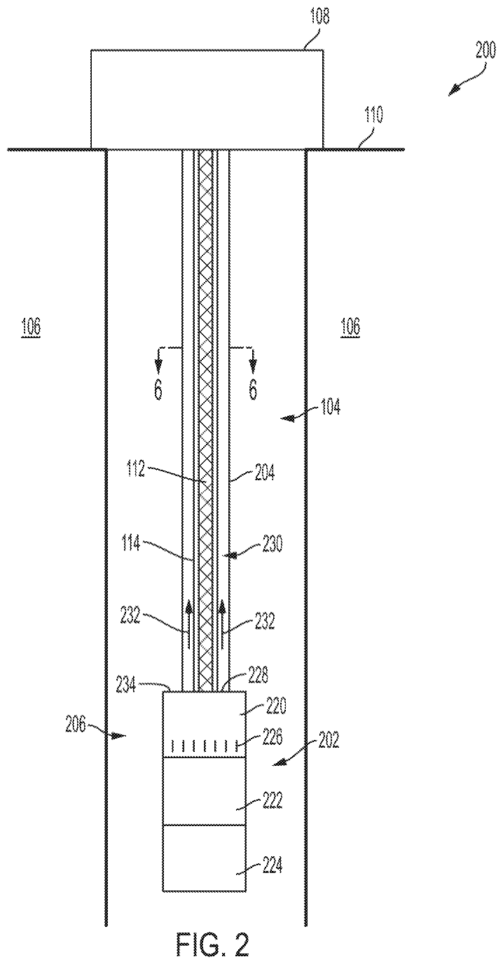

FIG. 2 is a cross-sectional view of another example of a well system 200 that includes an electric artificial lift system (EALS) 202 in a conventional orientation within the wellbore 104 according to some aspects. As discussed above with respect to FIG. 1, the wellbore 104 may extend through various earth strata such as the hydrocarbon bearing subterranean formation 106. The EALS 202 may be used in the production of production fluids from the wellbore 104. For example, the EALS 202 may pump the production fluids from a downhole location within the wellbore 104 to the wellhead 108 located at the surface 110 of the wellbore 104.

As illustrated, the EALS 202 is suspended from the wellhead 108 with the reinforced power cable 112 suspended within the coil tubing 114. In the illustrated example, the reinforced power cable 112 and the coil tubing 114 are also suspended within additional coil tubing 204 that is also coupled to the EALS 202, The reinforced power cable 112 includes an open-weave braid of reinforcing material. The reinforcing material may be a metal, a carbon fiber material, a reinforced tape material (e.g., a fibrous double reverse wound reinforced tape), or any other material suitable for providing reinforcement to the reinforced power cable 112.

In one or more examples, the reinforcing material may include a material (e.g., a reinforced tape material) that provides the reinforced power cable 112 with support, and also provides the reinforced power cable 112 with elasticity. For example, the elasticity of the reinforced power cable 112 may provide the reinforced power cable 112 with an ability to expand when deployed within the wellbore 104 due to heightened temperatures compared to an environment at the surface 110. Additionally, when the reinforcing material of the reinforced power cable 112 does not provide significant amounts of elasticity, the open-weave braid of the reinforcing material may enable expansion of elastomeric materials of a cable jacket of the reinforced power cable 112 through the open weave of the reinforcing material under heightened temperatures of downhole conditions. The elastic expansion of the reinforced power cable 112 may maintain structural stability of the reinforcing material in environments that are likely to result in expansion of the cable jacket (e.g., at heightened downhole temperatures).

The coil tubing 114 may be made from a sheet of stainless steel alloy, and the sheet of stainless steel alloy may be molded around the reinforced power cable 112 and welded at a seam to enclose the reinforced power cable 112 within the coil tubing 114. The reinforcing material may provide protection to the reinforced power cable 112 during the welding process such that the reinforced power cable 112 does not melt under the heat of the welding process. The coil tubing 114 may provide support for the weight of the EALS 202 when the EALS 202 is run into the wellbore 104. The coil tubing 114 and the reinforced power cable 112 may be stored together, prior to deployment within the wellbore 104, on a reel (not shown) at the surface 110.

The wellhead 108 may provide uphole support for both the reinforced power cable 112 and the coil tubing 114. The wellhead 108 may also electrically couple the reinforced power cable 112 to a power source (not shown) located at the surface 110. In this manner, the power from the power source may be transmitted along the reinforced power cable 112 to the EALS 102 located within the wellbore 104.

The additional coil tubing 204 may be manufactured in a similar manner to the coil tubing 114 around the coil tubing 114. For example, the coil tubing 204 may be made from similar sheets of stainless steel alloy, or other materials that are welded without an annealing process. In another example, the coil tubing 204 may be manufactured separately from the coil tubing 114, and the coil tubing 114 and the reinforced power cable 112 may be run into the coil tubing 204 prior to running the EALS 202 into the wellbore 104.

The EALS 202 may be run into the wellbore 104 to a production zone 206. The production zone 206 may be any area within the wellbore 104 where operators of the EALS 202 intend to produce production fluids. Deployment of the EALS 202 in a live-well environment may involve running the reinforced power cable 112, the coil tubing 114, and the coil tubing 204 through a grease injection head, or other sealing device, to maintain a pressure seal between the wellbore 104 and an environment at the surface 110. By maintaining the pressure seal, the EALS 202 is insertable within the wellbore 104 without using kill fluids that are potentially harmful to future productivity of the well system 200.

In an example, the EALS 202 is deployed within the wellbore 104 in a conventional orientation. That is, the EALS 202 includes a pump section 220 located in a position along the EALS 202 closest to the surface 110. The EALS 202 also includes a seal section 222 and a motor section 224. The pump section 220 may include fluid intake ports 226 that draw fluid into the EALS 202, and the pump section 220 may also include fluid discharge ports 228 that provide the production fluid into an annulus 230 between the coil tubing 114 and the coil tubing 204. The annulus 230 may form a space in which the production fluid is driven in a direction 232 toward the surface 110. The production fluid may be collected at the wellhead 108 and provided to a storage container (not shown) at the surface 110.

The fluid intake ports 226 and the fluid discharge ports 228 may be isolated from one another by the coil tubing 204. For example, the coil tubing 204 may be positioned to form a seal at uphole surface 234 between the EALS 202 and the production liner 116. In this manner, the annulus 230 between the coil tubing 114 and the coil tubing 204 is usable as a path for the production fluid to travel to the surface 110.

Similar to the EALS 102, the seal section 222 of the EALS 202 may include components that reduce a pressure differential between lubricant contained in the motor 224 and the fluid within the wellbore 104. The motor 224 may provide the mechanical power that drives operation of the pump section 220. Further, the motor 224 may receive electrical power from the reinforced power cable 112.

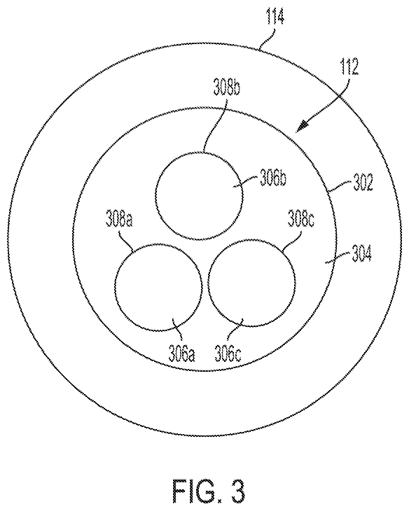

FIG. 3 is a sectional view of the reinforced power cable 112 and the coil tubing 114 of the well system of 100 according to some aspects. The reinforced power cable 112 may include a reinforcing layer 302 of open-weave material used to reinforce the reinforced power cable 112. By way of example, the reinforcing layer 302 may provide sufficient stability for the reinforced power cable 112 such that the reinforced power cable 112 is able to support a weight of the reinforced power cable 112 when the EALS 102 is deployed within the wellbore 104.

Within the reinforced layer 302, a cable jacket 304 may be installed around conductors 306a, 306b, and 306c of the reinforced power cable 112. The cable jacket 304 may provide an elastomeric and insulating coating around each of the conductors 306a-306c. The elastomeric nature of the cable jacket 304 may enable expansion and contraction of the cable jacket 304 in extreme conditions. For example, the cable jacket 304 may expand at high temperatures or during decompression without compromising a structural integrity of the reinforced power cable 112. In such an example, the cable jacket 304 may be made from ethylene propylene diene methylene (EPDM) rubber, polyethylene, or any other suitable insulating material. Further, the open-weave of the reinforcing layer 302 may allow the cable jacket 304 to expand between the open-weaves. In another example, an elasticity of the reinforcing layer 302 enable the reinforcing layer 302 to expand along with the expansion of the cable jacket 304 while still providing sufficient support for the weight of the reinforced power cable 112.

The conductors 306a-306c may each include an insulating layer 308a-308c surrounding the conductors 306a-306c individually. The insulating layers 308a-308c may provide insulating properties, in addition to the cable jacket 304, to prevent an occurrence of short circuits between the conductors 306a-306c. For example, while the cable jacket 304 may generally be insulative, manufacturing of the reinforced power cable 112 may result in two or more of the conductors 306a-306c being in contact with one another. The insulating layers 308a-308c may prevent any shorting between conductors 306a-306c regardless of physical contact between the insulating layers 308a-308c within the cable jacket 304. In one or more examples, the insulating layers 308a-308c may not be included surrounding the conductors 306a-306c. Further, while, the reinforced power cable 112 is illustrated as a three-phase power cable (i.e., with three conductors 306a-306c), the reinforced power cable 112 may be a single phase power cable or a polyphase power cable with more or fewer phases than the illustrated three-phase power cable. Additionally, the cable jacket 304 may also encapsulate instrument conductors, capillary tubing, optical fibers, or any combination thereof that run along a length of the reinforced power cable 112 along with the conductors 306a-306c.

As discussed above with respect to FIGS. 1 and 2, the coil tubing 114 may be formed around the reinforced power cable 112, as opposed to running the reinforced power cable 112 into the already manufactured coil tubing 114. By forming the coil tubing 114 around the reinforced power cable 112, a step of running the reinforced power cable 112 into the coil tubing 114 prior to deployment within the wellbore 104 may be eliminated. Avoiding running of the reinforced power cable 112 into the coil tubing 114 may decrease preparation time for a live well insertion of the EALS 102 and decrease costs associated with such preparation time.

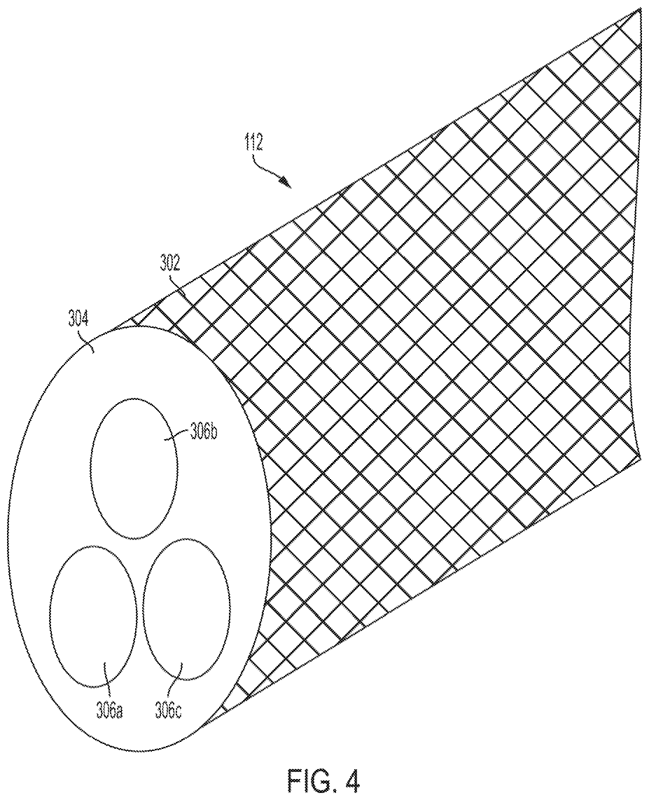

FIG. 4 is a perspective view of a portion of the reinforced power cable 112. As shown, the reinforcing layer 302 of the reinforced power cable 112 may include an open-weave arrangement. The open-weave arrangement may provide space through which the cable jacket 304 is able to expand under downhole conditions. Providing the ability for the cable jacket 304 to expand may prevent damage to the reinforcing layer 302 when the reinforced power cable 112 is operating under downhole conditions. Further, the open-weave arrangement may be any arrangement that provides open space between portions of the material that makes up the reinforcing layer 302. For example, the cable jacket 304 may be visible through openings in the reinforcing layer 302. In another example, the open-weave arrangement of the reinforcing layer 302 may enable some expansion of the reinforcing layer 302 without the cable jacket 304 being visible in openings in the reinforcing layer 302.

The reinforcing layer 302 may provide the reinforced power cable 112 with sufficient support to support a weight of the reinforced power cable 112 without having to crimp the coil tubing 114 for additional support of the reinforced power cable 112. The reinforcing layer 302 may also sufficiently support a weight of the EALS 102 in addition to the weight of the reinforced power cable 112 in an embodiment where the coil tubing 114 is not installed around the reinforced power cable 112.

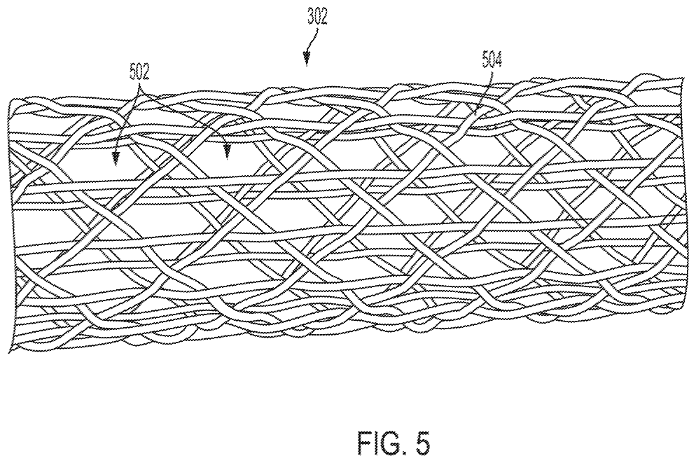

FIG. 5 is a side view of the reinforcing layer 302 according to some aspects. As illustrated, the reinforcing layer 302 includes openings 502 in the open-weave braid of the reinforcing layer 302. The openings 502 allow expansion of the cable jacket 304 of the reinforced power cable 112 under downhole conditions.

A reinforcing component 504 of the reinforcing layer 302 may be made from a metal, a carbon fiber material, a reinforced tape material, or any other material suitable for providing reinforcement to the reinforced power cable 112. As illustrated in FIG. 5, the reinforcing component 504 may be made from a generally cylindrical cord of reinforcing material. In another example, the reinforcing component 504 may be made from a generally flat sheet of reinforcing material. Further, the open-weave braid of the reinforcing layer 302 may be any braid design that provides sufficient support for the reinforced power cable 112. While the illustrated reinforcing layer 302 depicts the openings 502, in one or more examples, the reinforcing component 504 may overlap other portions of the reinforcing component 504 in such a manner to remove the openings 502 from the braid. In such an example, the reinforcing component 504 may be made from a material or made into a braid that allows for some expansion of the cable jacket 304 when the reinforced power cable 112 experiences downhole conditions.

The reinforcing layer 302 may be braided around the cable jacket 304 of the reinforced power cable 112. Braiding the reinforcing layer 302 around the cable jacket 304 may be an integral part of the manufacturing process. For example, the reinforcing layer 302 may be braided around the cable jacket 304 immediately upon manufacturing the cable jacket 304 around the conductors 306a-306c. In another example, the reinforcing layer 302 may be added in a post-production step. For example, the reinforcing layer 302 may be braided around the cable jacket 304 of a power cable that was previously manufactured.

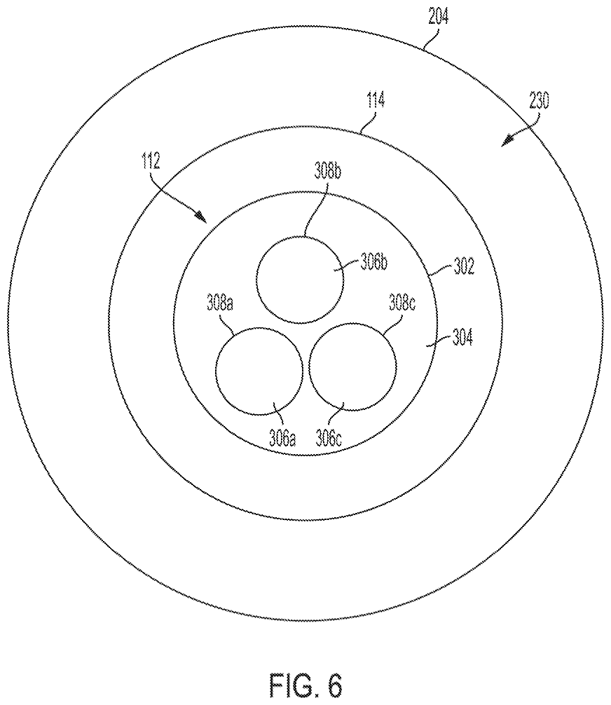

FIG. 6 is a sectional view of the power cable 112 and the coil tubing 114 positioned within the additional coil tubing 204 of the well system 200 according to some aspects. The reinforced power cable 112 may Include the reinforcing layer 302 of the open-weave material used to reinforce the reinforced power cable 112. By way of example, the reinforcing layer 302 may provide sufficient stability for the reinforced power cable 112 such that the reinforced power cable 112 is able to support a weight of the reinforced power cable 112 when the EALS 102 is deployed within the wellbore 104.

Within the reinforced layer 302, the cable jacket 304 may be installed around the conductors 306a-306c of the reinforced power cable 112. The cable jacket 304 may provide an elastomeric and insulating coating around each of the conductors 306a-306c. The elastomeric nature of the cable jacket 304 may enable expansion and contraction of the cable jacket 304 in extreme conditions. For example, the cable jacket 304 may expand at high temperatures or during decompression without compromising a structural integrity of the reinforced power cable 112. Further, the open-weave of the reinforcing layer 302 may allow the cable jacket 304 to expand between openings in the open-weave of the reinforcing layer 302. In another example, an elasticity of the reinforcing layer 302 may enable the reinforcing layer 302 to expand along with the expansion of the cable jacket 304 while still providing sufficient support for the weight of the reinforced power cable 112.

The conductors 306a-306c may each include the insulating layers 308a-308c surrounding the conductors 306a-306c individually. The insulating layers 308a-308c may provide insulating properties, in addition to the insulating properties of the cable jacket 304, to prevent an occurrence of short circuits between the conductors 306a-306c. For example, while the cable jacket 304 may generally be insulative, manufacturing of the reinforced power cable 112 may result in two or more of the conductors 306a-306c being in contact with one another. The insulating layers 308a-308c may prevent any shorting between conductors 306a-306c regardless of physical contact between the insulating layers 308a-308c within the cable jacket 304. In one or more examples, the insulating layers 308a-308c may not be included surrounding the conductors 306a-306c. Further, while, the reinforced power cable 112 is illustrated as a three-phase power cable (i.e., with three conductors 306a-306c), the reinforced power cable 112 may be a single phase power cable or a polyphase power cable with more or fewer phases than the illustrated three-phase power cable.

As discussed above with respect to FIGS. 1, 2, and 3, the coil tubing 114 may be formed around the reinforced power cable 112, as opposed to running the reinforced power cable 112 into the already manufactured coil tubing 114. By forming the coil tubing 114 around the reinforced power cable 112, a step of running the reinforced power cable 112 into the coil tubing 114 prior to deployment within the wellbore 104 may be eliminated. Avoiding running of the reinforced power cable 112 into the coil tubing 114 may decrease preparation time for a live well insertion of the EALS 202 and a decrease in costs associated with such preparation time. In another embodiment, the reinforced power cable 112 may be run into the coil tubing 114 rather than manufacturing the coil tubing 114 around the reinforced power cable 112.

The additional coil tubing 204 may be manufactured around the coil tubing 114 in a manner similar to how the coil tubing 114 is manufactured around the reinforced power cable 112. For example, the additional coil tubing 204 may be made from a sheet of stainless steel alloy or other metal suitable for use within the wellbore 104, and the sheet of stainless steel alloy may be molded around the coil tubing 114 and welded at a seam to enclose the coil tubing 114 within the additional coil tubing 204. In other embodiments, the coil tubing 114 and the reinforced power cable 112 may be run into a previously manufactured section of the additional coil tubing 204. The reinforced power cable 112, the coil tubing 114, and the additional coil tubing 204 may be stored together, prior to deployment within the wellbore 104, on a reel (not shown) at the surface 110.

During production of production fluid from the wellbore 104, the annulus 230 between the additional coil tubing 204 and the coil tubing 114 may provide a flow path for the production fluid from the EALS 202 to the surface 110 of the wellbore 104. Further, the additional coil tubing 204 may form a seal between the discharge ports 228 of the EALS 202 and other fluid within the wellbore 104 to enable movement of the production fluid from the EALS 202 to the surface 110. In an example, the coil tubing 114 may also form a seal with the EALS 202 to isolate the reinforced power cable 112 from the production fluids within the annulus 230.

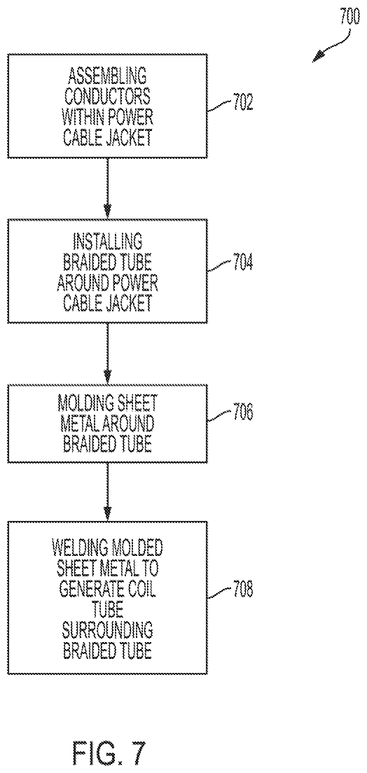

FIG. 7 is a flowchart of a process 700 for manufacturing the reinforced power cable 112 and the coil tubing 114 according to some aspects. At block 702, the process 700 involves assembling the conductors 306a-306c within the cable jacket 304. While the reinforced power cable 112 is described above as a three-phase power cable, the reinforced power cable 112 may include any number of phases. Accordingly, the reinforced power cable 112 may have more of fewer conductors than the conductors 306a-306c described above with respect to FIGS. 3, 4, and 6. For example, the reinforced power cable 112 may have one conductor or two conductors. In other examples, the reinforced power cable 112 may have more than three conductors. Moreover, the reinforce power cable 112 may include instrument conductors, capillary tubing, optical fibers, or any combination thereof. Further, the conductors 306a-306c may first be sheathed in the insulating layers 308a-308c before the cable jacket 304 is formed around the conductors 306a-306c. Further, the cable jacket 304 may insulate the conductors with ethylene propylene diene methylene (EPDM) rubber, polyethylene, or any other suitable insulating material. Further, in an example, the conductors 306a-306c may be shielded with lead.

At block 704, the process 700 involves installing a braided tube (e.g., the reinforcing layer 302) around the cable jacket 304. The reinforcing layer 302 may be braided around the cable jacket 304, or the cable jacket 304 may be run into the reinforcing layer 302. The open-weave braid of the reinforcing layer 302 provides the reinforced power cable 112 with sufficient structural integrity to support the weight of the reinforced power cable 112 and allow the cable jacket 304 to expand upon experiencing extreme temperatures and pressures in a downhole environment within the wellbore 104.

At block 706, the process 700 involves molding sheet metal around the braided tube. The sheet metal may include a sheet of stainless steel alloy or other material that is suitable for use while in contact with the production fluids from the wellbore 104. The sheet metal is molded around the reinforcing layer 302 to generally form a shape of the coil tubing 114 around the reinforced power cable 112. Molding the sheet metal may be accomplished by applying a molding force to the sheet metal or increasing a temperature of the sheet metal and applying the molding force to the sheet metal.

At block 708, the process 700 involves welding the molded sheet metal at a seam (e.g., edges of the molded sheet metal) to generate the coil tubing 114 surrounding the reinforced power cable 112. The welding process may occur without damaging the cable jacket 304. For example, the reinforcing layer 302 may provide the cable jacket 304 with sufficient protection from heat associated with the welding process to prevent melting of the cable jacket 304. Further, the sheet metal may be a type of metal that does not require an additional annealing process after performing the weld. Accordingly, additional heat from the annealing process that may damage the cable jacket 304 may be avoided. In an example, blocks 706 and 708 may be repeated with a different sheet of sheet metal to form the additional coil tubing 204 around the coil tubing 114.

In some aspects, systems, devices, and methods for implementing and manufacturing a reinforced power cable of an EALS are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: an electric artificial lift system; a power cable to provide power to the electric artificial lift system from a surface of a well, the power cable comprising: at least one conductor positioned within a cable jacket; a braided tube comprising an open-weave of a reinforcing component installed around the cable jacket; and a coil tube welded around the braided tube.

Example 2 is the system of example 1, wherein the at least one conductor comprises three conductors, and wherein each of the three conductors are positioned within three different conductor insulation layers.

Example 3 is the system of examples 1-2, wherein the open-weave of the reinforcing component comprises weaves of metal, carbon fibers, or reinforced tape.

Example 4 is the system of examples 1-3, wherein the cable jacket is visible through the braided tube from a position external to the braided tube.

Example 5 is the system of examples 1-4, wherein the coil tube comprises a sheet of stainless steel alloy molded around the braided tube.

Example 6 is the system of examples 1-5, further comprising a production liner positionable within the well, wherein the electric artificial lift system and the power cable are installable within the production liner.

Example 7 is the system of example 6, further comprising a packer positionable between the production liner and the electric artificial lift system to isolate an intake of the electric artificial lift system from an output of the electric artificial lift system.

Example 8 is the system of examples 1-7, further comprising an additional coil tube positioned around the coil tube, wherein an annulus between the coil tube and the additional coil tube defines a production fluid flow path to the surface of the well.

Example 9 is a method of manufacturing a power cable system, comprising: assembling at least one conductor within a power cable jacket; installing a braided tube around the power cable jacket; molding a sheet of metal around the braided tube and the power cable jacket; and welding edges of the molded sheet of metal to generate a coil tube surrounding the braided tube and the power cable jacket.

Example 10 is the method of example 9, further comprising installing the coil tube within an additional coil tube, wherein an annulus between the coil tube and the additional coil tube is usable to produce production fluids from an electric artificial lift system to a surface of a well.

Example 11 is the method of example 10, further comprising installing the electric artificial lift system to the coil tube in a conventional electrical artificial lift system orientation.

Example 12 is the method of examples 9-11, further comprising installing the coil tube downhole within a production liner, wherein an annulus between the coil tube and the production liner is usable to produce production fluids from an electric artificial lift system to a surface of a well.

Example 13 is the method of examples 9-12, further comprising installing an electric artificial lift system to the coil tube in an inverted electric artificial lift system orientation.

Example 14 is the method of examples 9-13, wherein the braided tube comprises an open-weave braid of metal, carbon fiber, or reinforced tape.

Example 15 is the method of examples 9-14, wherein welding the edges of the molded sheet of metal to generate the coil tube is performable without annealing a resulting weld.

Example 16 is a power cable, comprising; a cable jacket; at least one conductor positioned within the cable jacket and coupleable to an electric artificial lift system to provide power to the electric artificial lift system from a surface of a well; and a braided tube comprising an open-weave of a reinforcing component installed around the cable jacket.

Example 17 is the power cable of example 16, further comprising a coil tube welded around the braided tube.

Example 18 is the power cable of examples 16-17, further comprising a production tube positionable around the braided tube and coupleable to the electric artificial lift system.

Example 19 is the power cable of examples 16-18, further comprising: a first coil tube welded around the braided tube; and a second coil tube positioned around the first coil tube, wherein an annulus between the first coil tube and the second coil tube defines a production path of production fluids to the surface of the well.

Example 20 is the power cable of examples 16-19, wherein the open-weave of the reinforcing component comprises weaves of metal, carbon fiber, reinforced tape, or any combination thereof, and wherein the cable jacket is at least partially visible through the open-weave of the reinforcing component from a position external to the braided tube.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
an electric artificial lift system;
a power cable to provide power to the electric artificial lift system from a surface of a well, the power cable comprising:
at least one conductor positioned within a cable jacket;
a braided tube comprising an open-weave of a reinforcing component installed around the cable jacket; and
a coil tube welded around the braided tube.

2. The system of claim 1, wherein the at least one conductor comprises three conductors, and wherein each of the three conductors are positioned within three different conductor insulation layers.

3. The system of claim 1, wherein the open-weave of the reinforcing component comprises weaves of metal, carbon fibers, or reinforced tape.

4. The system of claim 1, wherein the cable jacket is visible through the braided tube from a position external to the braided tube.

5. The system of claim 1, wherein the coil tube comprises a sheet of stainless steel alloy molded around the braided tube.

6. The system of claim 1, further comprising a production liner positionable within the well, wherein the electric artificial lift system and the power cable are installable within the production liner.

7. The system of claim 6, further comprising a packer positionable between the production liner and the electric artificial lift system to isolate an intake of the electric artificial lift system from an output of the electric artificial lift system.

8. The system of claim 1, further comprising an additional coil tube positioned around the coil tube, wherein an annulus between the coil tube and the additional coil tube defines a production fluid flow path to the surface of the well.

9. A method of manufacturing a power cable system, comprising:
assembling at least one conductor within a power cable jacket;
installing a braided tube around the power cable jacket;
molding a sheet of metal around the braided tube and the power cable jacket; and
welding edges of the molded sheet of metal to generate a coil tube surrounding the braided tube and the power cable jacket.

10. The method of claim 9, further comprising installing the coil tube within an additional coil tube, wherein an annulus between the coil tube and the additional coil tube is usable to produce production fluids from an electric artificial lift system to a surface of a well.

11. The method of claim 10, further comprising installing the electric artificial lift system to the coil tube in a conventional electrical artificial lift system orientation.

12. The method of claim 9, further comprising installing the coil tube downhole within a production liner, wherein an annulus between the coil tube and the production liner is usable to produce production fluids from an electric artificial lift system to a surface of a well.

13. The method of claim 9, further comprising installing an electric artificial lift system to the coil tube in an inverted electric artificial lift system orientation.

14. The method of claim 9, wherein the braided tube comprises an open-weave braid of metal, carbon fiber, or reinforced tape.

15. The method of claim 9, wherein welding the edges of the molded sheet of metal to generate the coil tube is performable without annealing a resulting weld.

16. A power cable, comprising:
a cable jacket;
at least one conductor positioned within the cable jacket and coupleable to an electric artificial lift system to provide power to the electric artificial lift system from a surface of a well; and
a braided tube comprising an open-weave of a reinforcing component installed around the cable jacket.

17. The power cable of claim 16, further comprising a coil tube welded around the braided tube.

18. The power cable of claim 16, further comprising a production tube positionable around the braided tube and coupleable to the electric artificial lift system.

19. The power cable of claim 16, further comprising:
a first coil tube welded around the braided tube; and
a second coil tube positioned around the first coil tube, wherein an annulus between the first coil tube and the second coil tube defines a production path of production fluids to the surface of the well.

20. The power cable of claim 16, wherein the open-weave of the reinforcing component comprises weaves of metal, carbon fiber, reinforced tape, or any combination thereof, and wherein the cable jacket is at least partially visible through the open-weave of the reinforcing component from a position external to the braided tube.
